(19) United States
(12) Patent Application Publication
(10) Pub. No.: US 2013/0126082 A1
(43) Pub. Date: May 23, 2013

(54) METAL COPPER CLAD LAMINATE AND METHOD OF MANUFACTURING METAL CORE PRINTED CIRCUIT BOARD USING THE SAME

(71) Applicant: SAMSUNG ELECTRONICS CO., LTD., Suwon-si (KR)

(72) Inventors: Young Kyung KIM, Suwon (KR); Young Taek KIM, Hwaseong (KR)

(73) Assignee: SAMSUNG ELECTRONICS CO., LTD., Suwon-si (KR)

(21) Appl. No.: 13/680,491

(22) Filed: Nov. 19, 2012

(30) Foreign Application Priority Data
Nov. 18, 2011 (KR) 10-2011-0120866

(51) Int. Cl. B32B 15/08; B32B 27/28; B32B 3/26

(52) U.S. Cl. CPC B32B 15/08; B32B 3/26; B32B 27/281
USPC 156/250; 428/458; 428/473.5; 428/172; 428/457

(57) ABSTRACT

There are provided a metal copper clad laminate (MCCL) and a method of manufacturing a metal core printed circuit board (MCPCB) using the same. The MCCL includes a metal plate; a first polyimide adhesive layer laminated on the metal plate, the first polyimide adhesive layer having a shape corresponding to that of the metal plate so as not to expose an upper surface of the metal plate; a polyimide insulating layer laminated on the polyimide adhesive layer; and copper cladding laminated on the polyimide insulating layer.

### CROSS-REFERENCE TO RELATED APPLICATIONS

This application claims the priority of Korean Patent Application No. 10-2011-0120866 filed on Nov. 18, 2011, in the Korean Intellectual Property Office, the disclosure of which is incorporated herein by reference.

### BACKGROUND

1. Field

Embodiments relate to a metal copper clad laminate (MCCL) and a method of manufacturing a metal core printed circuit board (MCPCB) using the same.

2. Description of the Related Art

In the case of mounting an electronic component having a large amount of heat generation, e.g., a light emitting device using a light emitting diode (LED) on a substrate, a metal core printed circuit board (MCPCB) may be used in the related art to efficiently radiate heat generated in the electronic component through the substrate.

An MCPCB may be manufactured by etching copper cladding of a metal copper clad laminate (MCCL) using a related art method of manufacturing a printed circuit board (PCB). The MCCL may have a structure in which copper cladding of a circuit part and a metal plate for heat radiation are laminated. The MCCL may include an insulating layer interposed therebetween in order to electrically insulate the copper cladding and the metal plate. The insulating layer may be formed as a thin film having a thickness of about 10 μm using a high thermal conductivity material, in order to provide electrical insulation characteristics, to increase a heat radiation effect, and to efficiently conduct heat generated from the copper cladding having the electronic component mounted thereon to the metal plate.

The insulating layer of the MCCL may be formed by filling an epoxy based resin layer with a filler. The filler may be provided in order to increase thermal conductivity. However, damages may occur at a time of cutting the insulating layer. Damages may occur due to the filler provided, such that foreign objects, e.g., powder particles, etc., deteriorate the mass-productivity properties.

In addition, a regular scrap width portion should be secured in order to disperse stress. Dispersing stress prevents a breakage phenomenon at a time of pressing. Since scrap is discarded later, an improved method for decreasing an amount of scrap in the overall MCPCB is required.

### SUMMARY

An aspect of the exemplary embodiments may provide a metal copper clad laminate (MCCL) capable of maintaining thermal conductivity, avoiding damage to an insulating layer to prevent foreign objects, etc., from being detached therefrom during processing thereof and significantly decreasing scrap generation. An aspect of the exemplary embodiments may also provide a method of manufacturing a metal core printed circuit board (MCPCB) using the same.

According to an aspect of the exemplary embodiments, there is provided a metal copper clad laminate (MCCL) including: a metal plate; a first polyimide adhesive layer laminated on the metal plate, the first polyimide adhesive layer having a shape corresponding to that of the metal plate so as not to expose an upper surface of the metal plate; a polyimide insulating layer laminated on the polyimide adhesive layer; and copper cladding laminated on the polyimide insulating layer.

The MCCL may further include a second polyimide adhesive layer provided between the polyimide insulating layer and the copper cladding.

The MCCL may further include a cutting groove formed in a region of the polyimide insulating layer exposed by removing a portion of the copper cladding.

The cutting groove may be formed to have a predetermined depth from the upper surface of the metal plate, and the cutting groove through the polyimide insulating layer and the first polyimide adhesive layer.

The MCCL may further include a cover layer laminated on the copper cladding and the polyimide insulating layer, and the cover layer may have an opening exposing the cutting groove.

According to another aspect of the exemplary embodiments, there is provided a method of manufacturing a metal core printed circuit board (MCPCB), the method including: preparing a metal copper clad laminate (MCCL) having a metal plate and a polyimide adhesive layer, a polyimide insulating layer, and copper cladding sequentially laminated on the metal plate; exposing a portion of the polyimide insulating layer to the outside by removing a portion of the copper cladding; forming a cutting groove in the exposed portion of the polyimide insulating layer; and cutting and separating the MCCL along the cutting groove.

The MCCL may further include a cover layer covering the copper cladding and the polyimide insulating layer, and the cover layer may have an opening exposing the exposed portion of the polyimide insulating layer to the outside.

The opening may be formed by forming the cover layer in a state in which the exposed portion of the polyimide insulating layer is covered by a mask and then removing the mask.

The opening may be formed by removing a portion of the cover layer at a position corresponding to the exposed portion of the polyimide insulating layer.

According to another aspect of the exemplary embodiments, there is provided a metal copper clad laminate including: a rectangular plate; an insulating layer disposed on the rectangular plate; an adhesive layer disposed on and covering the insulating layer so as not to expose an upper surface of the insulating layer or an upper surface of the rectangular plate; and copper cladding disposed on the adhesive layer.

### BRIEF DESCRIPTION OF THE DRAWINGS

The above and other aspects, features and other advantages of the embodiments will be more clearly understood from the following detailed description, taken in conjunction with the accompanying drawings, in which:

FIG. 1 is a cross-sectional view schematically showing a metal copper clad laminate (MCCL) according to an embodiment;

FIGS. 2A and 2B are cross-sectional views schematically showing a modified example of the MCCL of FIG. 1;

FIG. 3 is a view schematically showing an MCCL according to another embodiment;

FIG. 4 is a cross-sectional view, taken along line X-X′ of FIG. 3;

FIG. 5 is a cross-sectional view schematically showing another embodiment of FIG. 4;

FIGS. 6 through 10 are views schematically showing a step-by-step method of manufacturing a metal core printed circuit board (MCPCB) according to an embodiment; and

FIGS. 11 and 12 are views schematically showing a step-by-step method of manufacturing an MCPCB according to another embodiment.

### DETAILED DESCRIPTION OF THE EMBODIMENTS

A metal copper clad laminate (MCCL) and a method of manufacturing a metal core printed circuit board (MCPCB) using the same according to embodiments will be described with reference to the accompanying drawings. However, the embodiments may be modified in many different forms and the scope of the present embodiments should not be limited to the embodiments set forth herein. Rather, these embodiments are provided so that this disclosure will be thorough and complete, and will fully convey the concept of the embodiments to those skilled in the art.

In the drawings, the shapes and dimensions of elements may be exaggerated for clarity. Further, the same reference numerals will be used throughout to designate the same or like elements.

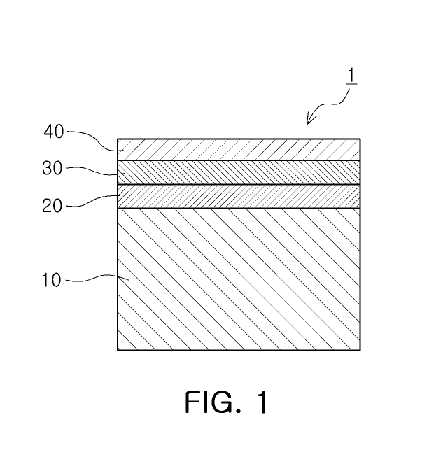

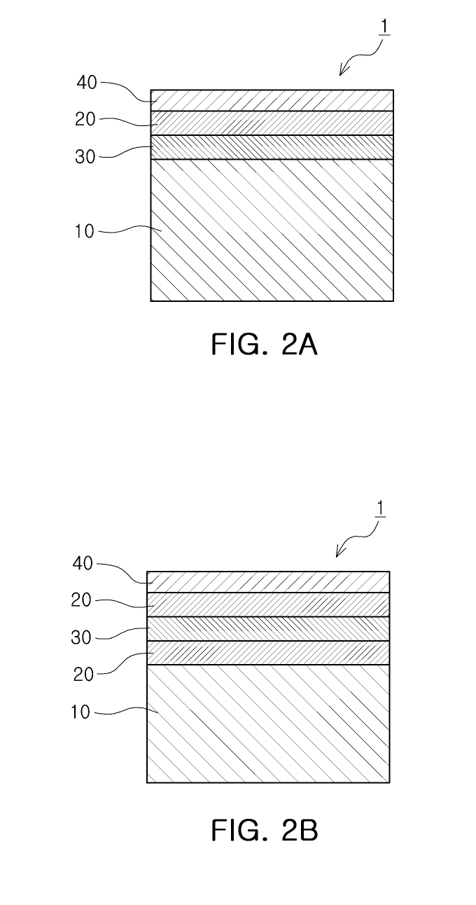

An MCCL according to an embodiment will be described with reference to FIGS. 1 and 2.

FIG. 1 is a cross-sectional view schematically showing an MCCL according to an embodiment, and FIGS. 2A and 2B are cross-sectional views schematically showing a modified example of the MCCL of FIG. 1.

Referring to FIGS. 1 and 2, an MCCL 1 according to an embodiment may include a metal plate 10, a polyimide adhesive layer 20, a polyimide insulating layer 30, and copper cladding 40 sequentially laminated thereon.

The metal plate 10 may have a rectangular parallelepiped structure having a predetermined size (e.g., 500 mm×600 mm), and be formed of a metal, e.g., as aluminum (Al), etc., having excellent thermal conductivity.

The polyimide adhesive layer 20 may be laminated on the metal plate 10, and the polyimide adhesive layer 20 may have a shape corresponding to the metal plate 10, so that an upper surface of the metal plate 10 is not exposed. The polyimide adhesive layer 20 having a thin sheet shape may be attached to the metal plate 10. In addition, the polyimide adhesive layer 20 may be formed on the metal plate 10 through a scheme, e.g., screen printing, coating, deposition, etc. The polyimide adhesive layer 20 may have strength properties resistant to fragility.

The polyimide insulating layer 30 may be laminated on the polyimide adhesive layer 20, and the polyimide insulating layer 30 may have a shape corresponding to the metal plate 10. The polyimide insulating layer 30 may be formed of a polyimide resin. The polyimide resin may include a filler. In addition, the polyimide insulating layer 30 may be firmly adhered to the metal plate 10 through the polyimide adhesive layer 20.

An insulating layer formed of an epoxy-based resin, according to the related art, needs to contain 60 to 80% of a filler and have a thickness maintained at 80 to 100 μm for improving thermal conductivity. This thermal conductivity would withstand voltage characteristics of the MCCL. However, the related art structure may be vulnerable to impacts at a time of a pressing process. In other words, the insulating layer and a PSR layer of the related art is fragile. Specifically, a portion cut by a punch may damage the insulating layer, etc., of the related art due to tensile stress, such that foreign objects may be detached therefrom or burrs may be generated. Therefore, in consideration of the problems of the related art, a partial region is secured and discarded as a scrap. Therefore, in the related art, manufacturing productivity has been decreased and manufacturing costs have increased.

In the embodiments, the polyimide resin-based insulating layer is resistant to fragility. This polyimide resin-based insulating layer is used instead of the related art epoxy resin based insulating layer, to solve the problems in the related art. The polyimide insulating layer of the embodiments may secure thermal conductivity equal to or higher than that of the related art. Further, the polyimide insulating layer of the embodiments may have strength properties resistant to fragility, to prevent the insulating layer from being damaged at the time of pressing.

In the polyimide insulating layer 30 of the related art, since a surface thereof may be slippery, it is not easy to bond the polyimide insulating layer to the metal plate 10. However, in the embodiments, the adhesion layer 20 formed of the polyimide based resin may be used, such that the polyimide insulating layer 30 may be firmly bonded to the metal plate 10. Specifically, since the adhesion layer 20 is formed of the polyimide based resin, similar to the insulating layer, the adhesion layer 20 may be prevented from being damaged at the time of pressing.

The copper cladding 40 may be laminated on the polyimide insulating layer 30. The copper cladding 40 may also have a shape corresponding to the metal plate 10, similar to the polyimide insulating layer 30. The copper cladding 40 may have a circuit wiring (not shown) through a subsequent patterning process.

As shown in FIG. 2A, the polyimide adhesive layer 20 may be provided between the polyimide insulating layer 30 and the copper cladding 40. In addition, as shown in FIG. 2B, the polyimide adhesive layer 20 may have a structure enclosing the polyimide insulating layer 30. Thus, the polyimide adhesive layer 20 may have a first polyimide adhesive layer 20 provided between the metal plate 10 and the polyimide insulating layer 30, and a second polyimide adhesive layer 20 is provided between the polyimide insulating layer 30 and the copper cladding 40. Therefore, the copper cladding 40 and the polyimide insulating layer 30 may be significantly firmly bonded to each other.

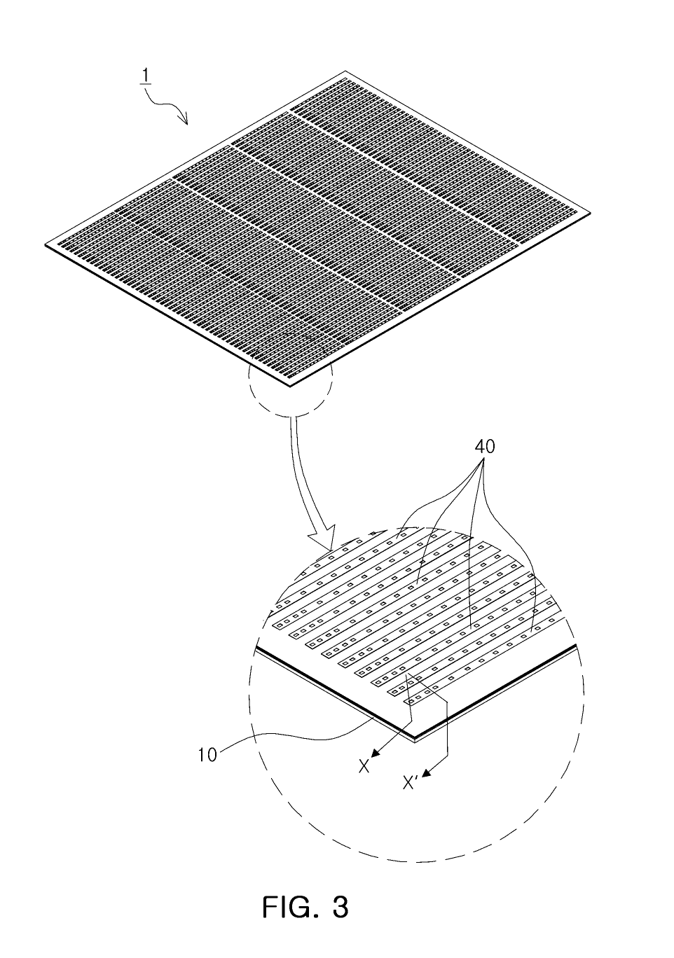

The MCCL according to another embodiment will be described with reference to FIGS. 3 through 5. A structure of the MCCL according to the embodiment shown in FIGS. 3 through 5 is substantially the same as that of the embodiment shown in FIG. 1. However, the structure of a polyimide insulating layer and a copper cladding is different from those of the embodiment shown in FIG. 1. Therefore, a description of the same structure as that of the above-mentioned embodiment will be omitted, and the structure of the polyimide insulating layer and the copper cladding will be described.

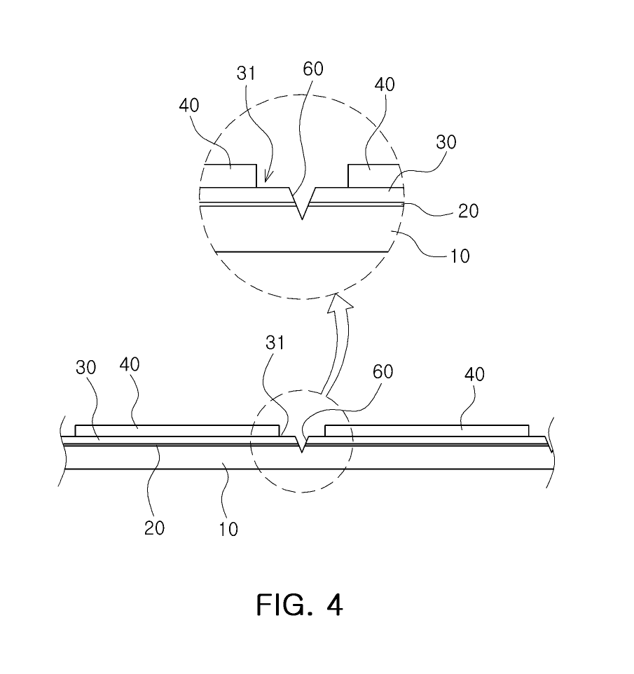

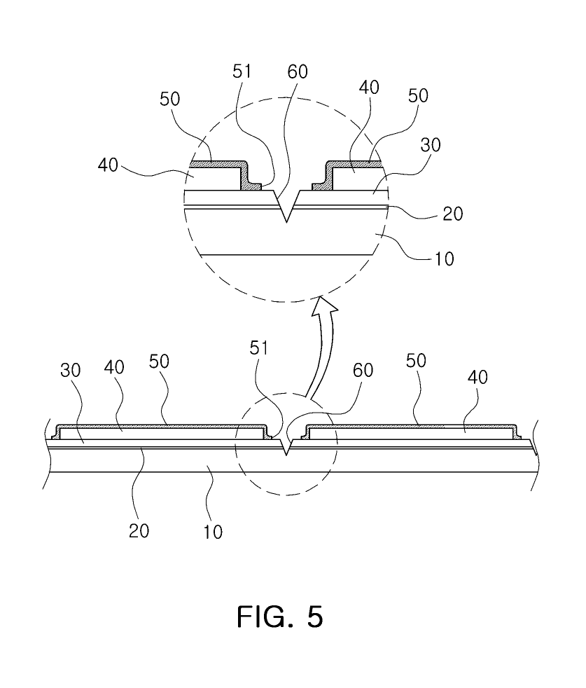

FIG. 3 is a view schematically showing an MCCL according to another embodiment, FIG. 4 is a cross-sectional view, taken along line X-X′ of FIG. 3, and FIG. 5 is a cross-sectional view schematically showing another embodiment of FIG. 4.

As shown in FIGS. 3 through 5, the polyimide insulating layer 30 may be provided to allow a partial region 31 thereof to be exposed outwardly through a removed portion of the copper cladding 40. In other words, the copper cladding 40 may be partially removed by etching, ablation, etc. Therefore, the partial region 31 of the polyimide insulating layer 30 may be exposed to the outside through the removed portion of the copper cladding 40. As described above, a procedure of removing a portion of the copper cladding 40 having a specific shape may be considered to be a kind of patterning procedure for forming a circuit wiring, and the copper cladding 40 remaining on the polyimide insulating layer 30 may be the circuit wiring of the substrate to be subsequently manufactured as a product. As shown in the drawings, the copper cladding 40 may be repeatedly removed in stripes with a predetermined interval therebetween. However, the shape of the removed portion is not limited thereto, and may be variously modified.

A cutting groove 60 may be formed in the partial region 31 of the polyimide insulating layer 30 exposed through a removed portion of the copper cladding 40. The cutting groove 60 having a “V” cross-sectional shape may be formed to have a predetermined depth from the upper surface of the metal plate 10 while penetrating through the polyimide insulating layer 30 and the polyimide adhesive layer 20. The cutting groove 60 may be formed along the region 31 exposed in the polyimide insulating layer 30 through punching, sawing, laser irradiation, etc. Although the cross-section of the cutting groove 60 is shown to have the “V” shape in the drawings, it is not limited thereto, and may be formed to have various other shapes. The cutting groove 60 may be a guide for the cutting of the MCCL in a process of manufacturing an MCPCB through a subsequent pressing process, etc. In particular, the cutting groove 60 may allow the MCCL to be easily cut without damage.

As shown in FIG. 5, a cover layer 50 may be further laminated on the copper cladding 40 and the polyimide insulating layer 30. The cover layer 50 may protect the copper cladding 40 by covering the copper cladding 40 exposed to the outside on the polyimide insulating layer 30, and may include the PSR layer.

The cover layer 50 may have an opening 51 exposing a portion of the exposed region 31 of the polyimide insulating layer 30 and the cutting groove 60. The opening 51 may be formed as a stripe along either side of the cutting groove 60, but is not limited thereto. In the case in which the MCCL is cut during the process of manufacturing the MCPCB through the subsequent pressing process, the opening 51 may prevent the cover layer 50 from being damaged. Further, the opening 51 may prevent the foreign objects from being detached therefrom, such that reliability of the product may be improved. The opening 51 may be formed by removing a portion of the cover layer 50 through etching, ablation, etc., but is not limited thereto.

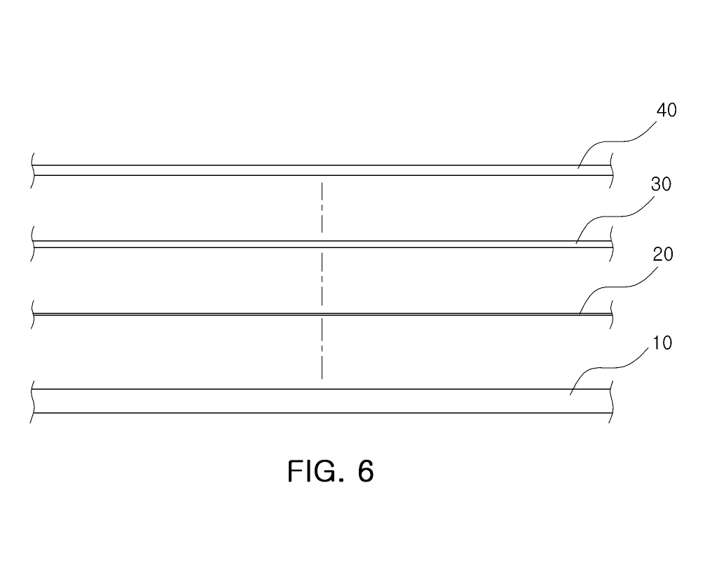

A method of manufacturing a metal core printed circuit board (MCPCB) according to an embodiment will be described with reference to FIGS. 6 through 10. FIGS. 6 through 10 are views schematically showing a step-by-step method of manufacturing an MCPCB according to an embodiment.

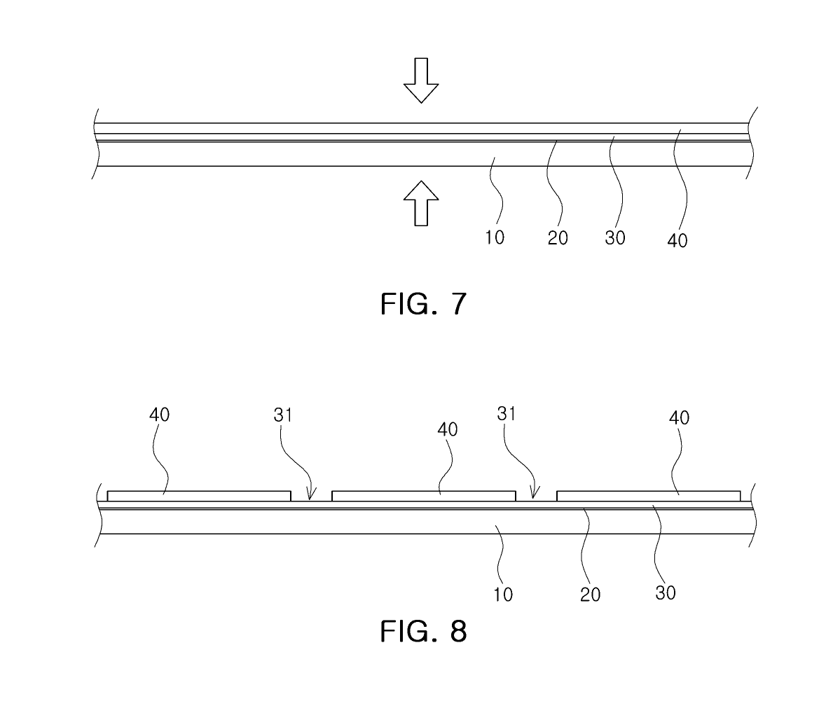

As shown in FIG. 6, the metal plate 10, the polyimide adhesive layer 20, the polyimide insulating layer 30, and the copper cladding 40 are prepared to have shapes corresponding to that of the metal plate 10. In addition, when preparing the MCCL 1, as shown in FIG. 7, hot pressing is performed in a state in which the polyimide adhesive layer 20, the polyimide insulating layer 30, and the copper cladding 40 are sequentially laminated on the metal plate 10, to bond them to each other. The metal plate 10 may have a rectangular parallelepiped structure having a predetermined size and be formed of a metal, e.g., aluminum (Al), etc., having excellent thermal conductivity. The polyimide insulating layer 30 and the copper cladding 40 may be provided separate from each other, or may be provided as a laminate.

Next, as shown in FIG. 8, a portion of the copper cladding 40 is removed, such that the partial region 31 of the polyimide insulating layer 30 is exposed outwardly through the removed portion of the copper cladding 40. The copper cladding 40 may be partially removed through etching, ablation, etc., such that the partial region 31 of the polyimide insulating layer 30 may be exposed to the outside through the removed portion of the copper cladding 40. As described above, a procedure of removing the portion of the copper cladding 40 having a specific shape may be considered to be a kind of patterning procedure for forming a circuit wiring. The copper cladding 40 remaining on the polyimide insulating layer 30 may be the circuit wiring of a substrate to be subsequently manufactured as a product.

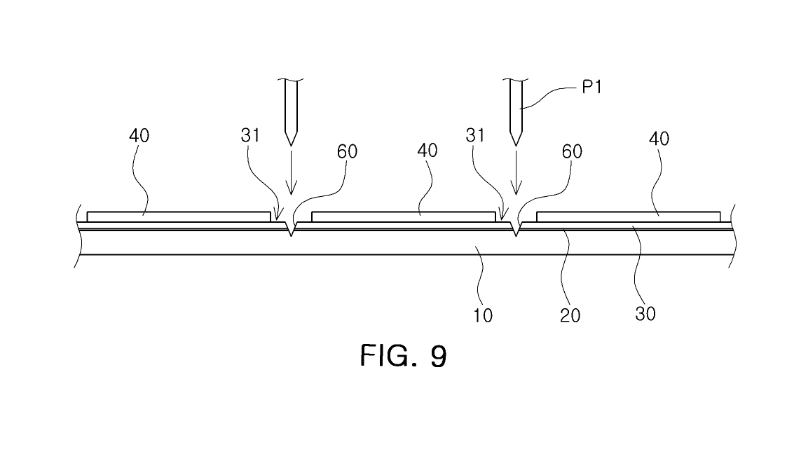

Next, as shown in FIG. 9, the cutting groove 60 is formed in the exposed region 31 of the polyimide insulating layer 30. The cutting groove 60 having a “V” cross-sectional shape may be formed to have a predetermined depth from the upper surface of the metal plate 10, while penetrating through the polyimide insulating layer 30 and the polyimide adhesive layer 20. The cutting groove 60 may be formed along the exposed region 31 of the polyimide insulating layer 30 by using a punching machine (P1). In addition, the cutting groove 60 may be formed by various methods, e.g., sawing, laser irradiation, etc. Although the cross-section of the cutting groove 60 is formed to have the “V” shape in the drawings, it is not limited thereto, and may be arbitrarily modified. The cutting groove 60 is a guide for the cutting of the MCCL 1 in a process of manufacturing the MCPCB 100 through a subsequent pressing process. In particular, the cutting groove 60 may allow the MCCL 1 to be easily cut without damage.

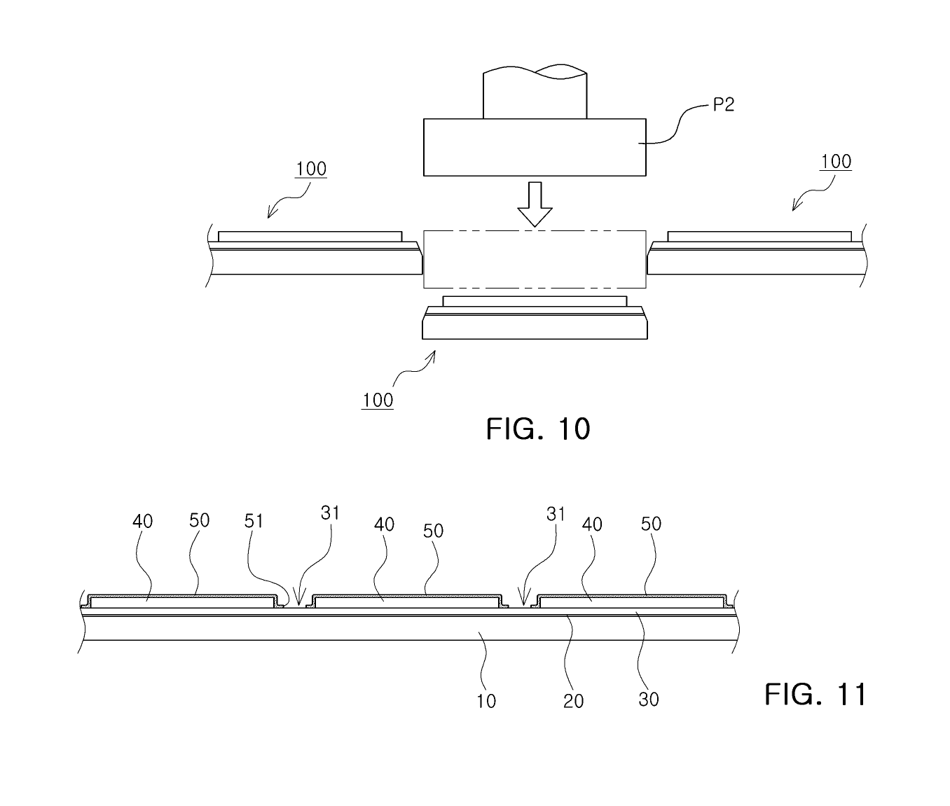

Next, as shown in FIG. 10, the MCCL 1 is cut and separated along the cutting groove 60. The MCCL 1 may be fixed to a jig (not shown), and may be cut along the cutting groove 60 through the pressing process using a pressing apparatus P2. The MCCL 1 cut, as described above, may be manufactured as a plurality of MCPCBs 100.

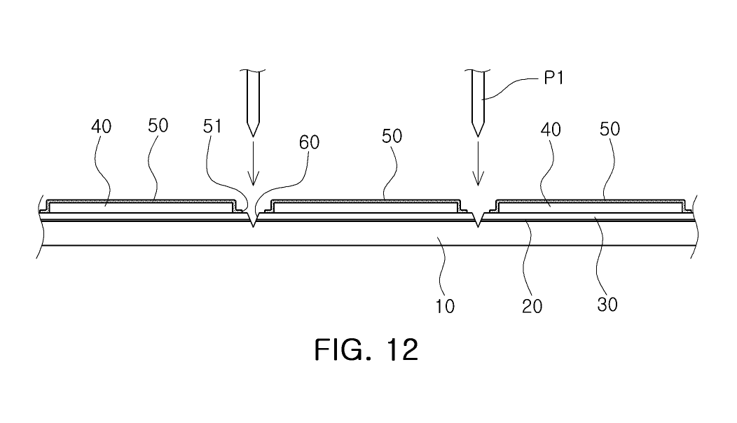

A method of manufacturing an MCPCB according to another embodiment will be described with reference to FIGS. 11 and 12 as well as FIGS. 6 through 10. FIGS. 11 and 12 are views schematically showing a step-by-step method of manufacturing an MCPCB according to another embodiment.

As shown in FIGS. 6 and 7, when preparing the MCCL 1, the metal plate 10, the polyimide adhesive layer 20, the polyimide insulating layer 30, and the copper cladding 40 having the shape corresponding to the metal plate 10 are sequentially laminated on the metal plate 10, and bonded to each other by hot-pressing.

Next, as shown in FIG. 8, the portion of the copper cladding 40 is removed to thereby expose the partial region 31 of the polyimide insulating layer 30 to the outside, through the copper cladding 40.

Next, as shown in FIG. 11, the cover layer 50 is formed so as to cover the copper cladding 40 and the portion of the polyimide insulating layer 30. The cover layer 50 may protect the copper cladding 40 by covering the copper cladding 40 exposed to the outside on the polyimide insulating layer 30, and may include a PSR layer.

The cover layer 50 has the opening 51 exposing the portion of the exposed region 31 of the polyimide insulating layer 30. The opening 51 may be formed as a stripe along either side of the cutting groove 60, but is not limited thereto. The opening 51 may prevent the cover layer 50 from being damaged in the case in which the MCCL 1 is cut during a process of manufacturing the MCPCB 100 through the subsequent pressing process. Further, the opening 51 may prevent the foreign objects from being detached therefrom, so that reliability of the product may be improved.

The opening 51 may be formed by forming the cover layer 50 in a state in which the exposed region 31 of the polyimide insulating layer 30 is covered by a mask (not shown) and then removing the mask. In addition, the opening 51 may be formed by removing a portion of the cover layer 50 through etching, ablation, etc., at a position corresponding to the exposed region 31 of the polyimide insulating layer 30.

Next, as shown in FIG. 12, the cutting groove 60 is formed in the region 31 of the polyimide insulating layer 30 exposed through the opening 51. The cutting groove 60 having a “V” cross-sectional shape may be formed to have a predetermined depth from the upper surface of the metal plate 10, while penetrating through the polyimide insulating layer 30 and the polyimide adhesive layer 20.

The cutting groove 60 may be formed after the opening 51 is formed in the cover layer 50, and the region 31 of the polyimide insulating layer 30 is exposed therethrough. Alternatively, the cutting groove 60 may first be formed in the exposed region 31 before the cover layer 50 is formed, the cover layer 50 may be formed, and the opening 51 may be then formed in the cover layer 50, such that the cutting groove 60 together with the region 31 of the polyimide insulating layer 30 may be exposed through the opening 51. In other words, the cutting groove 60 may first be formed before the cover layer 50 is formed, or be formed after the cover layer 50 is formed, and the order in which operations are carried out may be selected by a manufacturing technician.

Next, as shown in FIG. 10, the MCCL 1 is cut and separated along the cutting groove 60. The MCCL 1 may be fixed to a jig (not shown), and may be cut along the cutting groove 60 through the pressing process using the pressing apparatus P2. The MCCL 1 cut, as described above, may be manufactured as the plurality of MCPCBs 100.

As set forth above, according to embodiments, an MCCL capable of avoiding damages to an insulating layer to prevent foreign objects, etc., from being detached therefrom during processing may be prevented. Preventing foreign objects from being detached improves mass-productivity properties and significantly decreases scrap generation to reduce manufacturing costs. Further, embodiments may provide a method of manufacturing an MCPCB using the same.

While the embodiments have been shown and described in connection with the embodiments, it will be apparent to those skilled in the art that modifications and variations can be made without departing from the spirit and scope of the embodiments as defined by the appended claims.

What is claimed is:

1. A metal copper clad laminate (MCCL) comprising:
a metal plate;
a first polyimide adhesive layer laminated on the metal plate, the first polyimide adhesive layer comprising a shape corresponding to that of the metal plate so as not to expose an upper surface of the metal plate;
a polyimide insulating layer laminated on the polyimide adhesive layer; and
copper cladding laminated on the polyimide insulating layer.

2. The MCCL of claim 1, further comprising a second polyimide adhesive layer provided between the polyimide insulating layer and the copper cladding.

3. The MCCL of claim 1, further comprising a cutting groove formed in a region of the polyimide insulating layer exposed by removing a portion of the copper cladding.

4. The MCCL of claim 3, wherein the cutting groove is formed to have a predetermined depth from the upper surface of the metal plate, and the cutting groove penetrates through the polyimide insulating layer and the first polyimide adhesive layer.

5. The MCCL of claim 3, further comprising a cover layer laminated on the copper cladding and the polyimide insulating layer,
wherein the cover layer has an opening exposing the cutting groove.

6. A method of manufacturing a metal core printed circuit board (MCPCB), the method comprising:
preparing a metal copper clad laminate (MCCL) having a metal plate and a polyimide adhesive layer, a polyimide insulating layer, and copper cladding sequentially laminated on the metal plate;
exposing a portion of the polyimide insulating layer to an outside by removing a portion of the copper cladding;
forming a cutting groove in the exposed portion of the polyimide insulating layer; and
cutting and separating the MCCL along the cutting groove.

7. The method of claim 6, wherein the MCCL further includes a cover layer covering the copper cladding and the polyimide insulating layer, and
the cover layer has an opening exposing the exposed portion of the polyimide insulating layer to the outside.

8. The method of claim 7, wherein the opening is formed by forming the cover layer in a state in which the exposed portion of the polyimide insulating layer is covered by a mask, and then removing the mask.

9. The method of claim 7, wherein the opening is formed by removing a portion of the cover layer at a position corresponding to the exposed portion of the polyimide insulating layer.

10. A metal copper clad laminate (MCCL) comprising:
a rectangular plate;
an insulating layer disposed on the rectangular plate;
an adhesive layer disposed on and covering the insulating layer so as not to expose an upper surface of the insulating layer or an upper surface of the rectangular plate; and
copper cladding disposed on the adhesive layer.

11. The MCCL of claim 10, further comprising a cutting groove formed in a region of the adhesive layer exposed by removing a portion of the copper cladding.

12. The MCCL of claim 11, wherein the cutting groove is formed to have a predetermined depth from the upper surface of the rectangular plate, and the cutting groove penetrates through the adhesive layer and the insulating layer.

13. The MCCL of claim 11, further comprising a cover layer disposed on the copper cladding and the adhesive layer,
wherein the cover layer comprising an opening exposing the cutting groove.
